(19) United States
(12) Patent Application Publication
(10) Pub. No.: US 2019/0123370 A1
(43) Pub. Date: Apr. 25, 2019

(54) ADAPTIVE ELECTRICAL HEATER FOR FUEL CELL SYSTEMS

(71) Applicant: h2e Power Systems Pvt. Ltd., Pune (IN)

(72) Inventors: Rajendra MAYUR SIDDHARTH, Pune (IN); Ashok CHAKRADEO AMARNATH, Pune (IN); Ashok MOGRE PRIYANKA, Pune (IN); Motiram AHIRE NITIN, Pune (IN)

(21) Appl. No.: 16/093,303

(22) PCT Filed: Apr. 13, 2017
(86) PCT No.: PCT/IB2017/052152

§ 371 Date: Oct. 12, 2018

(30) Foreign Application Priority Data
Apr. 12, 2016 (IN) 201621012837

(51) Int. Cl. H01M 8/04858; H01M 8/04014; H01M 8/04007; H01M 8/04225; H01M 8/04223; H01M 8/04302; H01M 8/0432; H01M 8/04828; H01M 8/0612; H01M 8/0662

(52) U.S. Cl. CPC H01M 8/04953; H01M 8/04014; H01M 8/04037; H01M 8/04225; H01M 8/0662; H01M 8/04302; H01M 8/04335; H01M 8/0494; H01M 8/0618; H01M 8/04268

(57) ABSTRACT

The present disclosure provides a fuel cell system comprising a hot box, an air tube, an electrical heater and a thermal sensor. The hot box may comprise a fuel cell stack having a plurality of fuel cell units joined together. Each fuel cell unit of the fuel cell stack unit has an anode, a cathode and an electrolyte sandwiched between the anode and cathode. An air tube having an upper end and lower end is configured to receive ambient air at a second inlet. The electrical heater is integrated within the air tube and configured to heat the fuel cell stack by introducing hot air at a cathode side of a plurality of fuel cell units. Further, the fuel system is configured to operate in different modes comprising a startup mode, a normal mode, a dump load mode and hot standby mode with the use of the integrated electrical heater.

### TECHNICAL FIELD

The present disclosure relates to a fuel cell system more particularly relates to an electrical heater integrated inside the fuel cell system.

### BACKGROUND

Fuel cells generate electricity by converting chemical energy of a fuel (hydrogen) and an oxidant (oxygen or the air) into electrical power, with water vapor and heat as by products. The fuel cells provide high efficiency and can run continuously as long as fuel and oxidant is available. Unlike the conventional multistep processes involving chemical combustion and moving parts of engine, the fuel cell converts chemical energy of a fuel to electrical energy in one single step without the use of moving parts and thus providing greater efficiency. A fuel cell unit generally consists of an electrolyte, an anode and a cathode. Among the fuel cells, a solid oxide fuel cell, called as a third generation fuel cell, has a structure in which an anode is attached to one side of solid electrolyte and a cathode is attached to the another side of the electrolyte. Multiple solid oxide fuel cells are typically connected in series to form a fuel cell stack. In a solid oxide fuel cell, the electrolyte is a solid ceramic material and the cathode and anode are made from special inks. Moreover, no precious metals, corrosive acids or molten materials are required for solid oxide fuel cells.

In a solid oxide fuel cell, oxidizing flow is passed through the cathode side of the fuel cell while the reformed fuel is passed through the anode side. The oxidizing flow is typically of air and the reformed fuel is a hydrogen-rich gas generated by reforming a hydrocarbon fuel. As the electrochemical reaction starts in the fuel cell, the negatively charged oxygen ions from the cathode move to the anode via the electrolyte. The oxygen ions combine with the hydrogen and carbon monoxide from the reformed fuel and produces electricity, water and/or carbon dioxide. The produced water can further be recycled to produce steam needed to reform the fuel. The process also generates heat required by the fuel cell stack.

However, in the conventional solid oxide fuel cell having the above configuration, preheating the fuel and air can be performed using heat exchangers. These heat exchangers are connected to the fuel cell system as a separate structure placed external to the fuel cell system. In another configuration, separate heaters may be used for preheating the fuel and air of the fuel cell system. In yet another configuration gas fired start-up burners may be used for preheating the fuel/air to the fuel cell system. The external placement of heat exchangers/heaters to the fuel cell system involves high installation cost and complicates the system design. Moreover, during operation of the fuel cell stack, the air and fuel preheated by heat exchangers are not uniformly supplied to the reaction surfaces of fuel cell units stacked vertically. This non-uniform heating causes reaction gas shortage and the reactivity of the fuel cell stack is reduced, thus it significantly reduces the efficiency and performance of the fuel cell.

In some other configurations, the startup heater was used as a power dissipater when the generator is off-line, making the fuel cell generator to operate in a self-heating mode at a reduced power level. No configuration of the startup heater/power dissipater is disclosed for online load conditions of the fuel cell system

### OBJECT OF THE INVENTION

It is primary object of present disclosure to provide a fuel cell system with an electrical heater for an efficient startup of the fuel cell power generator.

It is another object of the present disclosure to provide a fuel cell system for making use of the electrical heater as a dump load during normal load conditions.

It is still another object of the present disclosure to provide a fuel cell system to operate in a hot standby mode with the use of the electrical heater.

### SUMMARY

The present disclosure relates to a fuel cell system configured to operate in a startup mode, a normal mode, a dump load mode and hot standby mode with the use of an electrical heater integrated in the fuel cell system. Unlike the prior art methods of heating the fuel cell system, the present disclosure uses the electrical heater to provide heat to the fuel cell system for a fast start-up, maintaining the operational temperature, consuming the excess power and eliminating the problems of excess noise, vibration and exhaust emissions of conventional fuel cell heating methods. The electrical heater not only reduces the startup time but also facilitates low power consumption by utilizing recovered heat from the exhaust via a heat exchanger and feeding it to the fuel cell stack.

In an aspect of the present disclosure, a fuel cell system comprising a hot box, an air tube, an electrical heater and a thermal sensor. The hot box may comprise a fuel cell stack having a plurality of fuel cell units joined together, each fuel unit has an anode, a cathode and an electrolyte sandwiched between the anode and the cathode. The hot box may further comprise a reformer connected to the fuel cell stack receiving hydrocarbon fuel at a first inlet and converting the hydrocarbon fuel into hydrogen-containing product gas, an afterburner unit connected to the fuel cell stack receiving exhaust gases from the fuel cell stack, and at least one insulating material placed to cover at least the fuel cell stack of the hot box. An air tube having an upper end and lower end is configured to receive ambient air at a second inlet. A portion of air tube integrated within the hot box may form a hot zone and a portion of air tube residing outside the hotbox may form a cold zone. The air tube may also comprise an outlet having at least one slot at the upper end for supplying hot air into the fuel cell stack. The electrical heater is integrated within the hot zone of the air tube. The electrical heater may heat the fuel cell stack of the hot box by introducing the generated hot air into cathode side of plurality of fuel cell units, and the hot air is uniformly distributed to each of the fuel cell unit from the plurality of fuel cells units. The fuel cell system may further comprise a thermal sensor located in the conduit of the air tube to measure the air temperature at the outlet of the air tube.

In another aspect of the present disclosure, a fuel cell system comprising a hot box, an air tube, an electrical heater and a thermal sensor. The hot box may comprise a fuel cell stack located coaxially relative to the central axis of the hot box. The fuel cell stack comprises a plurality of fuel cell units joined together, each fuel unit has an anode, a cathode and an electrolyte sandwiched between the anode and the cathode. The hot box may further comprise a reformer connected to the fuel cell stack receiving hydrocarbon fuel at a first inlet and converting the hydrocarbon fuel into hydrogen-containing product gas, an afterburner unit connected to the fuel cell stack receiving exhaust gases from the fuel cell stack, and at least one insulating material substantially placed to cover at least the fuel cell stack of the hot box. An air tube having an upper end and lower end is connected with the hot box, positioned vertically parallel to the central axis of the hot box, receiving ambient air at a second inlet. A portion of air tube integrated within the hot box may form a hot zone and a portion of air tube residing outside the hotbox may form a cold zone. The air tube may also comprise an outlet having at least one slot at the upper end for supplying hot air into the fuel cell stack. The fuel cell system may also comprise an insulated air bucket located at the upper end of the air tube, covering the outlet of the air tube for supplying hot air into the fuel cell stack. The electrical heater is integrated within the hot zone of the air tube along the central axis of the air tube. The electrical heater may generate hot air by heating the ambient air entering at the second inlet. The electrical heater may heat the fuel cell stack of the hot box by introducing the generated hot air into cathode side of plurality of fuel cell units of the fuel cell stack during start-up of fuel cell system, and dissipates the excessive power generated from the fuel cell system during a change in power demand. The electric air pre-heater comprises a heating element energized using a power supply unit. The fuel cell system may further comprise a thermal sensor located in the middle conduit of the air tube along the central axis to measure the air temperature at the outlet of the air tube.

### BRIEF DESCRIPTION OF THE DRAWINGS

The detailed description is described with reference to the accompanying figures.

FIG. 1, illustrates a shown a schematic representation of a fuel cell system in accordance with exemplary embodiment of the present disclosure.

FIG. 2, illustrates an arrangement of an electrical heater integrated in an air tube in accordance with the exemplary embodiment of the present disclosure.

FIG. 3, illustrates a perspective view of the fuel cell system in accordance with the present disclosure.

FIG. 4, illustrates a control system for the fuel cell system for power generation in accordance with the present disclosure.

### DETAILED DESCRIPTION OF THE INVENTION

A fuel cell system for power generation with an adaptive electrical heater is disclosed. The adaptive electrical heater heats the inlet air supplied to the fuel cell and provides an efficient startup heating required for power generation. The adaptive electrical heater may also be used as a dump load in the fuel cell system during online load conditions.

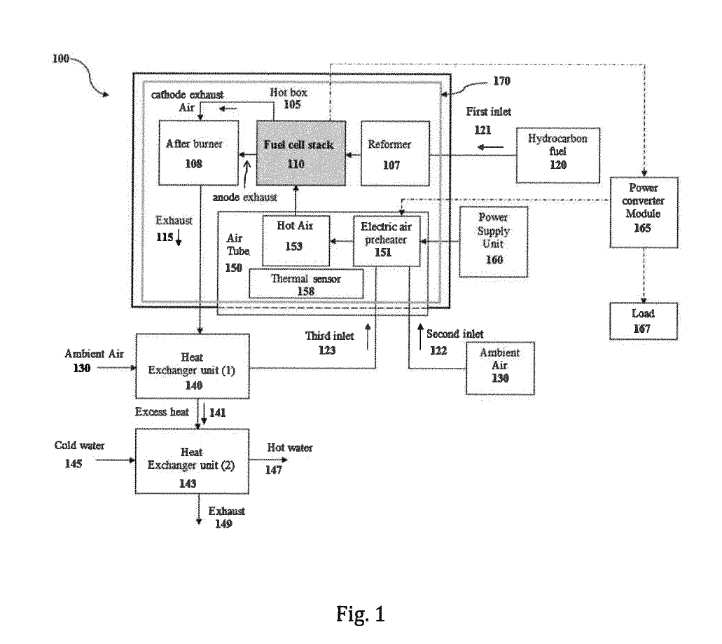

Referring to FIG. 1, illustrates a schematic representation of a fuel cell system in accordance with the present disclosure. The fuel cell system 100 may comprise a hot box 105 including a fuel cell stack 110, a reformer 107 and an afterburner 108. The hot box 105 may comprise at least one insulating material enclosing at least the fuel cell stack, the reformer and the afterburner. The fuel cell stack 110 comprises a plurality of fuel cell units joined together. Each of the fuel cell unit has an anode, a cathode and an electrolyte sandwiched between the cathode and the anode. The fuel cell unit may be a solid oxide fuel cell unit (SOFC). The electrolyte may be a solid material, e.g. a ceramic material, in case of solid oxide fuel cell unit. A hydrocarbon fuel 120 may be supplied to the fuel cell system 100 for power generation. The reformer unit 107 may receive hydrocarbon fuel 120 at a first inlet 121. The reformer converts the received hydrocarbon fuel 120 into hydrogen-containing product gas, which is further supplied to the fuel cell stack 110. Further, the afterburner 108 may be connected to the fuel cell stack 110 and configured to receive exhaust gases from the anode side and cathode side of the fuel cell stack 110. During power generation, the electrochemical reactions occur within the fuel cell stack and generate the exhaust gases with excessive heat.

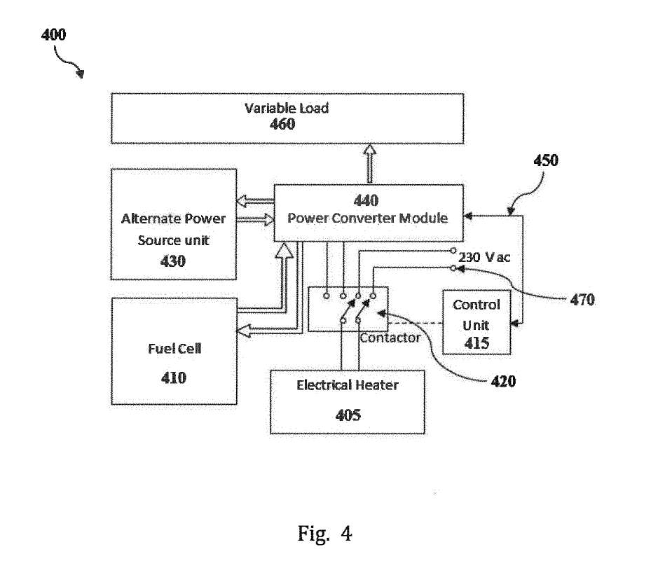

The fuel cell system may further comprise an air tube 150 connected with the hot box 110. A portion of the air tube 150 may be further integrated within the hot box 110 to at least partially form a hot zone, and the remaining portion of the air tube 150 may reside outside the hot box 110 to at least partially form a cold zone. In one embodiment of the present disclosure, the air tube is a metal tube. The fuel cell system may further comprise an electrical heater 151 integrated within the hot zone of the air tube 150. The electrical heater may comprise a heating element energized by a power supply unit 160. The electrical heater may be powered by the power supply unit 160 during a startup mode. The electrical heater may be powered by an alternate power supply unit through a power converter module 165 during a dump load mode. The alternate power supply unit and the power converter module 165 are shown in FIG. 4 below. Furthermore, the power converter module 165 may receive the generated power from the fuel cell stack 110 to charge the alternate power supply unit. In one embodiment of the present disclosure, the alternate power supply unit may comprise a battery. The electrical heater 151 may heat ambient air 130 entering to the air tube 150 at a second inlet 122 and generate hot air 153 in the air tube 150. The ambient air 130 may enter at the cold zone of the air tube 150, while the generated hot air flows through the hot zone of the air tube 150. The hot air flowing through the hot zone of the air tube 150 may be supplied through an outlet of the air tube for heating the fuel cell stack 110. The fuel cell system may further comprise a thermal sensor 158 located in a conduit of the air tube 150 to measure, and monitor the temperature of the air at the outlet of the air tube. In one implementation of the present disclosure, the thermal sensor may be N type thermocouple used for measuring the temperature of the air at the outlet of the air tube 150. Additionally, a first heat exchanger unit 140 may be placed in the path of exhaust outlet 115 and connected with the after burner unit 108. Further a part of heat generated by the after burner 108 during the exothermic reaction may be utilized to maintain the operational temperature of the components within Hot Box. The remaining heat generated in the after burner 108 may be dissipated to the first heat exchanger unit 140 wherein the heat exchanger 140 may further dissipate the heat to the incoming ambient air 130. The heated ambient air may be supplied into the air tube 150 at a third inlet 123. Further to the implementation, a second heat exchanger unit 143 may be placed in the path of exhaust of the first heat exchanger 140 configured to receive the excess heat 141 from the first heat exchanger unit 140. The second heat exchanger unit 143 is a hot water heat exchanger receiving excess heat 141 and exchanging the heat with the cold water 145 to produce hot water 147. The hot water may be used for hot storage tank or other heating applications. The received excess heat 141 is optionally transferred to an external water circuit for hot water preparation or heating the room.

The electrical heater 151 is essentially used for heating the fuel cell stack 110 to provide a fast startup of the fuel cell system 100 needed for power generation. In the fuel cell system, typically the electrochemical reactions occur at a temperature of about 830 degree Celsius. During startup, the fuel cell stack 110 needs to be heated at least to 680 degrees Celsius before the electrochemical reactions are initiated at the anode and cathode layers. The electrical heater 151 supplies sufficient heat to the fuel cell stack 110 in the hot box 105 to initiate electrochemical reactions. During the startup conditions of the fuel cell system, the hot air 153 is generated by the electrical heater and then introduced into the cathode side of plurality of fuel cell units of the fuel cell stack 110 at the outlet of air tube, thereby heating the fuel cell stack 110 of the hot box 105. The at least one insulation 170 or 171 of the hot box 105 may be arranged in such a way that to facilitate the simultaneous heat transfer within the hot box 105 or reduce the heat dissipated from the hot box 105. The at least one insulation 171 may have high thermal conductivity allowing simultaneous heat transfer between core components of hot box 105. The at least one insulation 170 may have a low thermal conductivity helping to retain the heat in the hot box and prevent heat loss to the external environment. The at least one insulation 170 or 171 of the hot box 105 provides a better thermal insulation to the fuel cell stack. The at least one insulation 170 or 171 of the hot box 105 may comprise multiple insulating materials. In some embodiments, the at least one insulation 170 or 171 may be a graded insulation comprising multiple insulating materials arranged together. In a preferred embodiment, the at least one insulation 170 or 171 of the hot box 105 may comprise a plurality of calcium silicate boards. The at least one insulation 170 or 171 helps to maintain uniform heating to the fuel cell stack 110. The at least one insulation 170 or 171 further helps in maintaining high temperature during electrochemical reactions of the fuel cell units by preventing heat loss.

Further to the embodiment, the electrical heater 151 may act as a power dissipater during on-line load conditions of the fuel cell system. During an operation of the fuel cell system, different load conditions may be observed. The connected load in a grid system may be a lighter, or a heavy load. Due to the continuous fuel supply and with the continuous electrochemical reactions of the fuel cell stack, there is always a full amount of electrical power generated by the fuel cell system. When there is a sudden change in the connected load, also referred to as partial load conditions, excess electrical power is generated in the system and is unused. The stagnant electrons at the anode side may affect the key component of the fuel cell system such as electrolyte of the fuel cell units. The excess unused power can be stored/dissipated as heat by an integral part of the fuel cell system. In the exemplary embodiment, the electrical heater dissipates the excessive power generated from the fuel cell system in a form of ‘heat’ during partial load condition. Thus, during load ramp down conditions, the electrical heater can be used as a dump load, thereby preventing damages to the key components. Further the dissipated heat can be used for preheating the fuel/air supplied to the fuel cell stack.

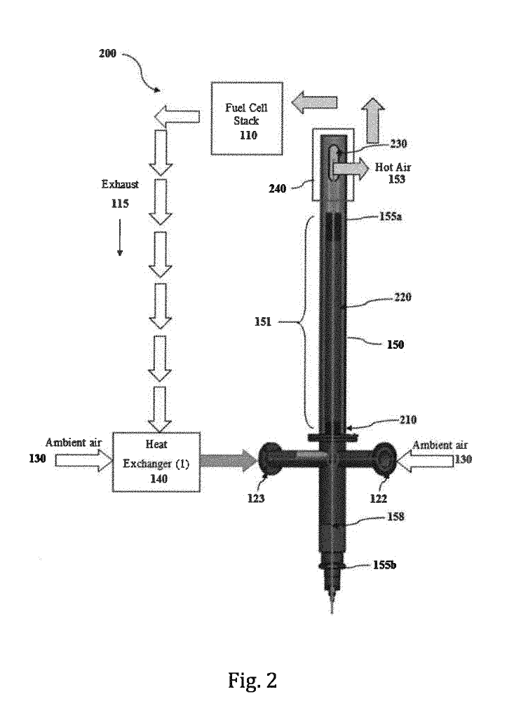

Referring to the FIG. 2, there is shown an arrangement 200 of the electrical heater 151 integrated in the air tube 150 in accordance with the exemplary embodiment of the present disclosure. The air tube comprises an upper end 155a and a lower end 155b, connected to the hot box 105 described in FIG. 1. As described in the above, the air tube 150 receives the ambient air 130 at the second inlet 122. The portion of the air tube resided outside the hot box receiving the ambient air, forming a cold zone 210 of the air tube 150. The remaining portion integrated within the hot box may be used for heating the fuel cell stack 110, forming a hot zone of the air tube 150. The electric air pre heater 150 is integrated within hot zone 220 of the air tube along the central axis of the air tube 150. The electric air pre heater may comprise a heating element supplied by a power supply unit. The electrical heater heats the ambient air 130 entering at second inlet 122 and generates the hot air 153. The upper end 155a of the air tube comprises an outlet 230 for supplying the generated hot air into the fuel cell stack 110. The upper end 155a of the air tube further may comprise an insulated air bucket 240 covering the outlet 230 of the air tube 150. The hot air 153 may be supplied into the cathode side of plurality of fuel cell units of the fuel cell stack 110 and may provide sufficient heat to initiate electrochemical reactions for power generation. The outlet portion 230 may consist of at least one slot and supply the hot air into the fuel cell stack 110. The hot air at the outlet is at a temperature about 800 degrees Celsius. The thermal sensor is located in the middle conduit of the air tube 150 along the central axis of the air tube 150. The thermal sensor 158 may be a N type thermocouple, used for measuring the air temperature at the outlet 230 of the air tube 150. In one implementation, the thermal sensor 158 may be used for measuring and monitoring the air temperature at the hot zone 220 of the air tube 150. In such cases, the sensing junction is located in the middle of the air tube 150. The first heat exchanger 140 further may receive exhaust gases and excessive heat, and exchange with the ambient air 130 to be supplied to the air tube at the third inlet 123. The exhaust gases are in a temperature about 400 degrees Celsius. The electrical heater 151 integrated in the air tube 150 is connected with the hot box in such a way that the electric preheater 151 assembly can be independently removed and/or replaced without opening the hot box 105 assembly. Further, the electric air pre heater is strategically positioned in the air tube to uniformly heat the fuel cell stack via diffused heating. With such connection of the electric preheater, the present disclosure provides an advantage of less cost involved in maintenance requirements with the electrical heater arrangement.

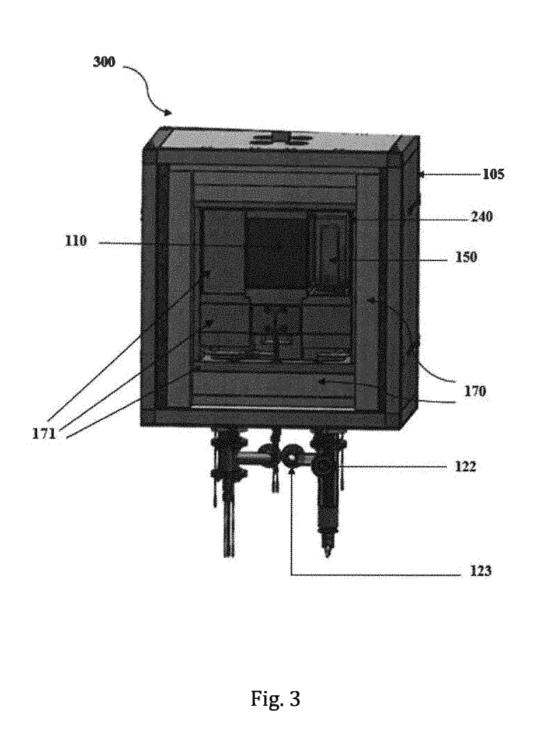

Referring to FIG. 3, there is shown a perspective view of the fuel cell system in accordance with the present disclosure. The fuel cell stack system 300 comprises the hot box 105 enclosing the fuel cell stack 110 located coaxially relative to the central axis of the hot box 105. The air tube 150 may be a metal tube, vertically positioned parallel to the central axis of the hot box 105. The tube material may be selected from a group of high temperature alloys. The group may comprise IN519, Inconel 625, HK40 materials and similar high temperature alloys. The air tube 150 has a thickness about 1.5 millimeters to 3 millimeters. The hot box 105 may also comprise at least one insulating material 170 placed substantially to cover at least fuel cell stack 110 of the hot box 105, providing a better thermal insulation during electrochemical reactions.

Referring to FIG. 4, there is shown a control system 400 of the fuel cell system for power generation in accordance of the present disclosure. The fuel cell 410 is a solid oxide fuel cell (SOFC). A control unit (CU) 415 is used to provide operating parameters for the electrical heater 405 during online load conditions. A variable load 460 may be connected with a power converter module 440 and provides dynamic loads to the power generating system. Further the control unit (CU) 415 may be configured to operate the electrical heater 405 under dynamic load conditions. A contactor 420 may be used as a switch for electrical heater 405 to connect with the power converter module 440 or with a 230V AC power supply 470. The switching of contactor 420 in connection with the electrical heater 405 enables the fuel cell system to be operated in four different modes including (i) a startup mode (ii) a normal mode (iii) a dump load mode and (iv) a standby mode.

During startup mode of the fuel cell system, the control unit (CU) 415 provides the ON-OFF control signal to the contactor 420 for switching on the electrical heater 405. The contactor as a switching unit makes a connection between the electrical heater 405 and the 230V AC power supply 470, and the electrical heater 405 is powered by 230 V power supply 470. Once startup is over, the electrical heater 405 is configured to work under the normal operating conditions (also referred as ‘normal mode/load conditions’). The control unit (CU) 415 provides the ON-OFF control signal to the contactor 420 for disconnecting the electrical heater 405 from the 230V power supply unit 470 and the fuel cell system starts to operate in dump load mode (also referred as ‘part load mode’). The fuel cell system 400 may comprise an alternate power source unit 430 for providing an alternative power supply to the electrical heater 405. The alternate source power unit may comprise a DC power source, a solar power generator, a wind power generator and/or a battery. The fuel cell power may be fed to the battery for charging through the power converter module 440. Once the battery is fully charged the electrical heater 405 starts to work as a dump load and dissipates excessive power generated from fuel cell system 400 in the form of heat. Other alternate power sources viz., the DC source, the solar power generator, the wind power generator also used for charging the battery. The set points for operating electrical heater 405 as the dump load may be provided to the fuel cell system over a communication link 450. The communication link 450 may be a two wire RS-485 communication network.

Further, the fuel cell system may be kept in hot standby mode or hibernation mode when the fuel cell system in not used for generating electrical power. During this mode, the normal hydrocarbon fuel supply and processes, and air processes may be reduced, or stopped. The electrical heater 405 may be powered by the alternate power supply unit through the power converter module 440. The control circuit 415 may enable the electrical heater 405 to make a connection with the power converter module 440 to provide a heat to the fuel cell during the hibernation mode. The heat helps to maintain the internal temperature of fuel cell 410 near the operating temperature of the fuel cell 410. However, the fuel cell system may be restarted from hibernation mode to avoid the significant time delay in power generation.

In one embodiment of the present disclosure, the electrical heater 151 used is a single phase multi-cell insertion heater with independently controlled heated zones. The electrical heater may comprise a heating element supplied by an alternating current power supply unit. The heating element is a resistive element in nature and offers an indifferent resistance to the type of power supply used. The resistive elements may be designed in various forms comprising a coil, a wire, a spiral, a rod and any other suitable form. The power supply used may be an alternating power supply or a direct current power supply. In one embodiment of the present disclosure, the alternating current power supply unit may be a 230 V single phase power supply with a frequency of 50 Hz. In another embodiment of the present disclosure, the alternating current power supply unit may be a 110 V single phase power supply with a frequency of 60 Hz. The electrical heater is particularly designed to be positioned in the cathode inlet air tube integrated in the hot box, such that the higher heat is transferred to the component within hot box is achieved. Moreover, a higher air inlet temperature during startup is also possible, thereby reducing the startup time. The integration of the electric heater into the hotbox facilitates faster heating via multiform heat transfer to the fuel cell system. Initially the air passing through the heating element heats the fuel cell stack via convection. Additionally the heat is recovered from the exhaust via heat exchanger and fed to the electrical heater. As the electrical heater is enclosed within a high temperature air tube in vicinity of the fuel cell stack, the heat is also transferred via radiation. With the use of additional heat exchanger unit placed at the exhaust, the air is preheated with the use of exhaust gas prior to entering the electrical heater, hence the power rating of the electrical heater is reduced for the fuel cell system.

The electrical heater may receive electricity from a power grid for heating the fuel cell system. The power grid may be a 230 V alternating current power supply unit. The electrical heater heats the ambient air flowing through the conduit of the air tube and maintains the air temperature at a range of 700 to 1000 degrees Celsius for the startup process of fuel cell system. The ambient air may have a flow rate of 200 slm. The heating of the ambient air may occur in tube through convection and/or radiation process. Further an outer insulation of the hot box may prevent the heat loss from the hot box. The insulating material for the outer insulation may be calcium silicate boards with thermal conductivity range of 0.02 to 0.05 W/mK. The fuel cell system may comprise of inner insulation integrated within the hotbox. The inner insulation may be configured to enable heat transfer within the hotbox components. The inner insulation may be of a castable material with thermal conductivity in range about 0.2 to 0.4 W/mK.

On successful starting of the electricity generation by the fuel cell system, the alternating current power supply unit may be disconnected from the fuel cell system. The load or series of loads can be connected to the fuel cell system. The electrical heater dissipates the excessive electricity available in the fuel cell system due to sudden change/drop in the connected load. The excessive power available for dissipation is a Direct current (DC) power. As discussed in the above, the excessive power generated is dissipated as heat in the electrical heater and can be used for preheating the system. The electrical heater compensates the changes in the connected load of the fuel cell system by consuming the excessive power during online load conditions, and thus acts as a dump load. Thus, the electrical heater preserves the dual functionality in the fuel cell system, works as a dump load/power dissipater during online load conditions and works as a startup heater during startup of fuel cell system.

With the four operating modes, the electrical heater prevents the exposure of fuel cell electrolyte to the conditions that could accelerate the degradation of the electrolyte during sudden load reduction/changes. The fuel cell requires a definite amount of time to reduce the current for any load variations due to long time constant of fuel cells. In case of sudden load reduction, the excess electrons after the load current may form a deposition layer on electrodes of the fuel cell stack and may affect the life time of the key components like electrolyte of the fuel cell stack. The dump load mode prevents such deposition of electrons and helps in increasing the life time of the fuel cell stack. Thus dump load mode is essential during accidental load cut-off, no load or reduced load conditions.

The present disclosure with the electrical heater provides an advantageous design with reduced complexity, higher reliability and lower cost compared to the existing preheaters used in μCHP systems such as gas-fired start-up burners. The electrical heater further provides efficient and a faster startup needed for the fuel cell system and also provides a dual application for the fuel cell system by working as a startup heater and a dump load. The recovered heat from the exhaust due to strategic placement results in lower power rating of the electrical heater. As the electric preheater is an integral part of the fuel system, the present disclosure provides a reduced component design and manufacturing, low cost of installation and requires less space. Also, the power is not wasted as in case of dump load, the excessive power is dissipated as heat and useful in preheating the fuel/air. Thus, the present disclosure provides a cost effective fuel cell system with lower power consumption, better efficiency and also with better thermal integration.

Although the invention has been disclosed in the context of certain aspects and embodiments, it will be understood by those skilled in the art that the present invention extends beyond the specific embodiments to alternative embodiments and/or uses of the invention and obvious implementations and equivalents thereof. Thus, it is intended that the scope of the present invention disclosed herein should not be limited by the disclosed aspects and embodiments above.

I/We claim:

1. A fuel cell system comprising:
a hot box;
an air tube having an upper end and a lower end, wherein the air tube is configured to receive ambient air at a second inlet, a first portion of said air tube is integrated within the hot box to form a hot zone, and a second portion of said air tube is resided outside the hotbox to form a cold zone, wherein the air tube further comprises an outlet having at least one slot at the upper end for supplying hot air into a fuel cell stack;
an electrical heater integrated within the air tube, wherein the electrical heater heats the fuel cell stack by introducing hot air at a cathode side of a plurality of fuel cell units, wherein the hot air is uniformly distributed to each of the fuel cell unit from the plurality of fuel cells units; and
a thermal sensor located in the conduit of the air tube to measure the air temperature at the outlet of the air tube.

2. The fuel cell system as claimed in claim 1, wherein the hot box further comprises the fuel cell stack having the plurality of fuel cell units connected together, wherein each fuel cell unit has an anode, the cathode and an electrolyte sandwiched between the anode and the cathode.

3. The fuel cell system as claimed in claim 1, wherein the hot box further comprises a reformer connected to the fuel cell stack, configured to receive hydrocarbon fuel at a first inlet and converting the hydrocarbon fuel into hydrogen-containing product gas.

4. The fuel cell system as claimed in claim 1, wherein the hot box further comprises an afterburner unit connected to the fuel cell stack, configured to receive exhaust gases from the fuel cell stack.

5. The fuel cell system as claimed in claim 1, wherein the hot box further comprises at least one insulating material enclosing the fuel cell stack, the reformer and the afterburner.

6. The fuel cell system as claimed in claim 1, further comprises a heat exchanger unit positioned between the afterburner and the air tube, wherein the heat exchanger is configured to recover excessive heat from exhaust gases delivered by the afterburner unit and exchanging the heat at a third inlet with the incoming ambient air supplied into the air tube.

7. The fuel cell system as claimed in claim 1, wherein the thermal sensor is a N type thermocouple.

8. The fuel cell system as claimed in claim 1, the heating element of the electrical heater is a resistive element designed in a form comprising at least one of a spiral, a coil, a rod or a wire.

9. The fuel cell system as claimed in claim 1, wherein the electrical heater dissipates the excessive power in form of heat during a change in connected load.

10. The fuel cell system as claimed in claim 1, the electrical heater integrated in the air tube is connected with the hot box in such a way that the electrical heater is independently removed/replaced from the hotbox without opening the hot box.

11. The fuel cell system as claimed in claim 1, wherein the uniform heating is achieved via diffused heating.

12. The fuel cell system as claimed in claim 1, the at least one insulating material of the hot box is configured to provide a uniform heating to the fuel cell stack.

13. The fuel cell system as claimed in claim 1, the at least one insulating material of the hot box is configured to prevent heat loss from the fuel cell stack.

14. The fuel cell system as claimed in claim 1, the at least one insulating material is calcium silicate board.

15. The fuel cell system as claimed in claim 1, the air tube is a metal tube.

16. The fuel cell system as claimed in claim 1, the metal tube is made of a material selected from a group of high temperature alloys comprising IN519, Inconel 625 or HK40.

17. The fuel cell system as claimed in claim 1, the air tube has a thickness about 1.5 millimeters to 3 millimeters.

18. A fuel cell system comprising:
a hot box, wherein the hot box comprising;
a fuel cell stack having a plurality of fuel cell units joined together, located coaxially relative to the central axis of the hot box, wherein each fuel cell unit has an anode, a cathode and an electrolyte sandwiched between the anode and the cathode;
a reformer connected to the fuel cell stack, configured to receive a hydrocarbon fuel at a first inlet and converting the fuel into hydrogen-containing product gas;
an afterburner unit connected to the fuel cell stack, configured to receive exhaust gases from the fuel cell stack;
at least one insulating material placed substantially to cover the fuel cell stack of the hot box;
an air tube having an upper end and a lower end, wherein the air tube is configured to receive ambient air at a second inlet, positioned vertically parallel to the central axis of the hot box, a portion of said air tube is integrated within the hot box and forming a hot zone, a portion of said air tube is resided outside the hotbox and forming a cold zone, wherein the air tube further comprises an outlet having at least one slot at the upper end for supplying hot air into the fuel cell stack;
an insulated air bucket, located at the upper end of the air tube covering the outlet of the air tube for supplying hot air into the fuel cell stack;
an electrical heater integrated within hot zone of the air tube along the central axis of the air tube; and
a thermal sensor located in the middle conduit of the air tube along the central axis, to measure the air temperature at the outlet of the air tube.

19. The fuel cell system as claimed in claim 18 further comprises a heat exchanger unit placed in the path of the exhaust, recovering excessive heat from exhaust gases delivered by the afterburner unit and exchanging the heat at a third inlet with the incoming ambient air supplied into the air tube.

20. The fuel cell system as claimed in claim 18, wherein the fuel cell system is configured to operate in at least one mode selected from a start-up mode, or a normal mode, or a dump load mode, or a hot standby mode.

21. The fuel cell system as claimed in claim 20, wherein during the start-up mode of the fuel cell system the electrical heater is configured to receive power from a power supply unit and the electrical heater heats the fuel cell stack of the hot box by introducing the generated hot air into cathode side of plurality of fuel cell units of the fuel cell stack.

22. The fuel cell system as claimed in claim 20, wherein during the dump load mode of the fuel cell system the electrical heater is disconnected from the power supply unit and electrical heater dissipates excessive power generated from the fuel cell system.

23. The fuel cell system as claimed in claim 20, wherein during the hot standby mode of the fuel cell system the electrical heater is configured to receive power from an alternate power supply unit through a power converter module and electrical heater provides the heat to the fuel cell system to maintain the temperature of the fuel cell stack proximate to an operating temperature of the fuel cell stack.

24. The fuel cell system as claimed in claim 23, wherein during the hot standby mode of the fuel cell system is configured to not generate power.

25. The fuel cell system as claimed in claim 18, wherein the electrical heater comprises a heating element energized using the power supply unit.

26. The fuel cell system as claimed in claim 25, the heating element of the electrical heater is a resistive element designed in a form comprising at least one of a spiral, a coil, a rod and a wire.

27. The fuel cell system as claimed in claim 18, the electrical heater integrated in the air tube is connected with the hot box in such a way that the electrical heater is independently removed/replaced from the hotbox without opening the hot box.

28. The fuel cell system as claimed in claim 18, the electrical heater is strategically positioned in the air tube to uniformly heat the fuel cell stack via diffused heating.

29. The fuel cell system as claimed in claim 18, the at least one insulating material of the hot box configured to provide a uniform heating to the fuel cell stack.

30. The fuel cell system as claimed in claim 18, the air tube has a thickness about 1.5 millimeters to 3 millimeters.
